(19) United States
(12) Patent Application Publication
(10) Pub. No.: US 2018/0141856 A1
(43) Pub. Date: May 24, 2018

(54) THERMALLY INSULATING GLASS FOR OVENS AND PREPARATION METHOD THEREOF

(71) Applicant: DONGGUAN SHINE GLASS CO., LTD, Dongguan (CN)

(72) Inventor: Shulin Xiong, Dongguan (CN)

(21) Appl. No.: 15/877,296

(22) Filed: Jan. 22, 2018

(30) Foreign Application Priority Data
Jun. 8, 2017 (CN) 201710430413.7

(51) Int. Cl. C03C 17/36

(52) U.S. Cl. CPC C03C 17/3686; C03C 17/3605; C03C 2217/28; C03C 2218/156; C03C 2217/256; C03C 17/3644

(57) ABSTRACT

A thermally insulating glass for ovens includes a glass substrate, a thermally insulating layer and a protective layer. The glass substrate has an inner and outer surfaces, and the inner or/and outer surfaces are coated with the thermally insulating layer made of silver. The protective layer made of silicone oil is coated on the thermally insulating layer for protecting the thermally insulating layer from being oxidized. Silver can greatly enhance thermally insulating performance and reduce heat dissipation and energy consumption. Based on the high temperature resistance, protective properties and transparency of the silicone oil layer, the protective layer prevents the thermally insulating layer from being oxidized, and the work status can be observed. The process of preparing the thermally insulating glass is simple and the cost is low.

### RELATED APPLICATIONS

This application claims the benefit of priority to Chinese Patent Application No. 201710430413.7 filed in Jun. 8, 2017, which is hereby incorporated by reference in its entirety.

### FIELD OF THE INVENTION

The present invention relates to a field of ovens, more particularly to a thermally insulating glass for ovens and a method of preparing the thermally insulating glass.

### BACKGROUND OF THE INVENTION

Oven is one of household appliances in kitchen, which bakes food by radiant heat generated by heating elements. Ovens can be used to cook wheaten food, such as bread, pizza, or desserts including egg tarts, biscuits and the like. According to different requirements of different baked foods, temperature in the ovens can be adjusted in the range of 50-250° C. If thermally insulating performance of thermally insulating glass for ovens is poor, heat will radiate faster and more energy will be consumed. Currently, thermally insulating glass for ovens generally adopts double or multi-layer glass structures, such as FTO conductive glass and ITO conductive glass. As known, silver has very good thermally insulating performance and is often used as thermal insulation layer. If silver is used as the thermally insulating layer of thermally insulating glass for ovens, oven's thermally insulating performance will be greatly enhanced. However, silver is easily oxidized in the air and it is difficult to achieve thermally insulating effect. Therefore, the glass with the silver layer as thermally insulating layer cannot be used like the ordinary glass. It is necessary for a glass substrate to be coated with an oxide layer and a silver layer sequentially coated to form multi-layer thermally insulating glass, in order to protect the silver layer. Such a process is complex and costly obviously.

Thus it's necessary to provide a thermally insulating glass for ovens with a silver layer as thermally insulating layer, which can improve thermally insulating performance, simplify manufacturing process and reduce cost.

### SUMMARY OF THE INVENTION

One objective of the present invention is to provide a thermally insulating glass for ovens with a silver layer as thermally insulating layer, thereby greatly improving thermally insulating performance, simplifying manufacturing process and reducing cost.

To achieve the above objective, a thermally insulating glass for ovens is provided, which includes a glass substrate, a thermally insulating layer and a protective layer. The glass substrate has an inner surface and an outer surface, and the inner surface or/and the outer surface is/are coated with the thermally insulating layer made of silver. The protective layer made of silicone oil is provided on the thermally insulating layer for protecting thermally insulating layer from being oxidized.

In comparison with the prior art, the thermally insulating glass for ovens includes a glass substrate, a thermally insulating layer and a protective layer. A silver layer is served as the thermally insulating layer to greatly enhance thermally insulating performance of the thermally insulating glass, which reduces heat dissipation and energy consumption. Based on high temperature resistance and protective properties of silicone oil layer, a silicone oil layer is used as the protective layer to prevent the silver layer from being oxidized. Besides, the silicone oil layer does not affect transparency of the thermally insulating glass due to transparency of silicone oil, thus the work status of oven can be observed through the thermally insulating glass. Furthermore, since silicone oil is cheap and easy to spray, the process of preparing the thermally insulating glass is simple and the cost is low.

Preferably, the silicone oil is methyl silicone oil or modified silicone oil.

Concretely, the modified silicone oil is any one selected from groups of alcoholic hydroxyl-modified silicone oil, alkyl-modified silicone oil, polyether-modified silicone oil, epoxy-modified polysiloxane and amino-modified silicone oil. Preferably, alcoholic hydroxyl-modified silicone oil which is terminated with alcoholic hydroxyl group or has alcoholic hydroxyl group in the main chain is selected. Since hydroxyl groups among the terminals of the main chains or molecular chains have reactivity, thus crosslink will be generated when suffering from heating, thereby enhancing tear strength, abrasion resistance and heat resistance properties of the protective layer made of alcoholic hydroxyl-modified silicone oil. Such a protective layer can achieve higher density compared with other modified silicone oil and has wider applicability on anti-oxidation. For example, if a product is required to be heated to higher temperature, such a protective layer made of alcoholic hydroxyl-modified silicone oil is desirable to be coated thereon.

More concretely, thickness of the silicone oil layer is 20-50 μm. If thickness of the silicone oil layer is less than 20 μm, service life of the thermally insulating glass is shorter. Thickness of the silicone oil layer is optimal among 20-50 μm, and if thickness is greater than 50 μm, cost is higher.

The present invention also provides a method of preparing a thermally insulating glass for ovens, and the method includes:

step a, providing a glass substrate comprising an inner surface and an outer surface;

step b, providing a thermally insulating layer made of silver on the inner surface and/or the outer surface of the glass substrate; and

step c, coating a protective layer made of silicone oil on the surface of the thermally insulating layer.

Preferably, the step b further includes placing the glass substrate in a first vacuum chamber for magnetron sputter coating with target material being silver. Then silver is coated on the inner and/or outer surfaces of the glass substrate to form the thermally insulating layer at 100° C.-250° C.

Preferably, before the step c, temperature is gradually cooled down to room temperature. Concretely, the glass substrate is in turn placed in multiple vacuums chambers to be gradually cooled down after the thermally insulating layer is coated, so that the thermally insulating layer exhibits excellent thermally insulating performance.

Preferably, the step c further includes moving the glass substrate to a second vacuum chamber filled with inert gas. Then the protective layer made of silicone oil is coated on the thermally insulating layer.

Preferably, after the step c, the glass substrate is gradually depressurized after the protective layer is coated to obtain the thermally insulating glass. Concretely, the glass substrate is gradually depressurized through multiple vacuum chambers after the protective layer is coated, so that density of the silicon oil layer can be increased to protect the thermally insulating layer.

Preferably, the glass substrate is cleaned and dried between the step a and the step b to increase binding force of the thermally insulating layer and the glass substrate.

### BRIEF DESCRIPTION OF THE DRAWINGS

The accompanying drawings facilitate an understanding of the various embodiments of this invention. In such drawings:

FIG. 1 is a schematic view of a thermally insulating glass for ovens according to one embodiment of the present invention; and

FIG. 2 is a schematic view of a thermally insulating glass for ovens according to another embodiment of the present invention.

### DETAILED DESCRIPTION OF ILLUSTRATED EMBODIMENTS

The present invention will be described with reference to the accompanying drawings, in which like reference numerals refer to similar elements.

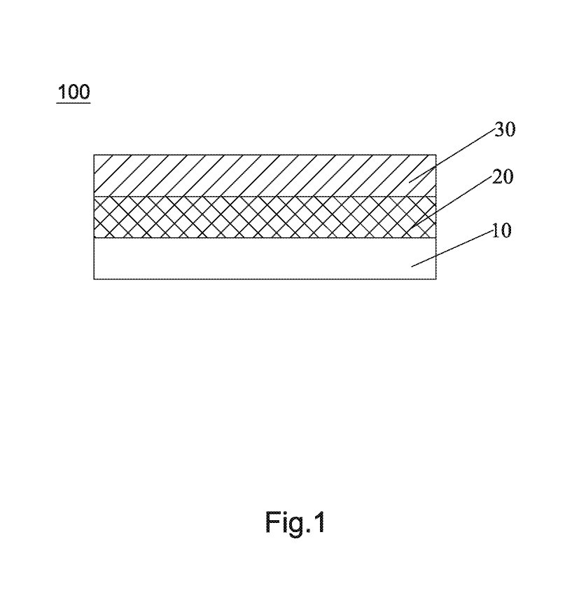

In embodiment 1, as shown in FIG. 1, the thermally insulating glass for ovens 100 includes a glass substrate 10, a thermally insulating layer 20 and a protective layer 30. The glass substrate 10 has an inner surface and an outer surface, and the outer surface is coated with the thermally insulating layer 20 made of silver. The protective layer 30 made of methyl silicone oil is coated on the thermally insulating layer 20 for protecting the thermally insulating layer 20 from being oxidized. Thickness of the protective layer 30 is 20 μm.

In embodiment 2, as shown in FIG. 1, the thermally insulating glass for ovens 100 includes a glass substrate 10, a thermally insulating layer 20 and a protective layer 30. The glass substrate 10 has an inner surface and an outer surface, and the inner surface is coated with the thermally insulating layer 20 made of silver. The protective layer 30 made of methyl silicone oil is coated on the thermally insulating layer 20 for protecting the thermally insulating layer 20 from being oxidized. Thickness of the protective layer 30 is 30 μm. Since heat in the ovens diffuse from inside to outside, the thermally insulating layer 20 is disposed on the inner surface of the glass substrate 10, so as to effectively prevent heat from diffusing.

In embodiment 3, as shown in FIG. 1, the thermally insulating glass for ovens 100 includes a glass substrate 10, a thermally insulating layer 20 and a protective layer 30. The glass substrate 10 has an inner surface and an outer surface, and the outer surface is coated with the thermally insulating layer 20 made of silver. The protective layer 30 made of epoxy modified polysiloxane is coated on the thermally insulating layer 20 for protecting thermally insulating layer 20 from being oxidized. Thickness of the protective layer 30 is 20 μm. As epoxy-modified polysiloxane is organosilicon materials polymerized by polymethylsiloxane and epoxyalkane with characteristics of polymethylsiloxane and epoxyalkane. Compared with the protective layer 30 formed by methyl silicone oil, the surface tension of the protective layer 30 formed by epoxy-modified polysiloxane is low, so the problems referring to embrittlement and cracking can be solved. Based on ageing-resistant performance of the protective layer 30 formed by epoxy-modified polysiloxane, service life of the protective layer 30 is longer.

In embodiment 4, as shown in FIG. 1, the thermally insulating glass for ovens 100 includes a glass substrate 10, a thermally insulating layer 20 and a protective layer 30. The glass substrate 10 has an inner surface and an outer surface, and the outer surface is coated with the thermally insulating layer 20 made of silver. The protective layer 30 made of alcoholic hydroxyl-modified silicone oil is coated on the thermally insulating layer 20 for protecting thermally insulating layer 20 from being oxidized. Thickness of the protective layer 30 is 20 μm. Alcoholic hydroxyl-modified silicone oil is terminated with alcoholic hydroxyl group or has alcoholic hydroxyl group in the main chain, so alcoholic hydroxyl-modified silicone oil has reactivity. Crosslink will be generated when alcoholic hydroxyl-modified silicone oil suffering from heating, thereby enhancing tear strength, abrasion resistance and heat resistance properties of the protective layer 30 made of alcoholic hydroxyl-modified silicone oil. Such a protective layer can achieve higher density compared with the protective layer 30 made of other modified silicone oil and has wider applicability on anti-oxidation. For example, if a product is required to be heated to higher temperature, such a protective layer made of alcoholic hydroxyl-modified silicone oil is desirable to be coated thereon.

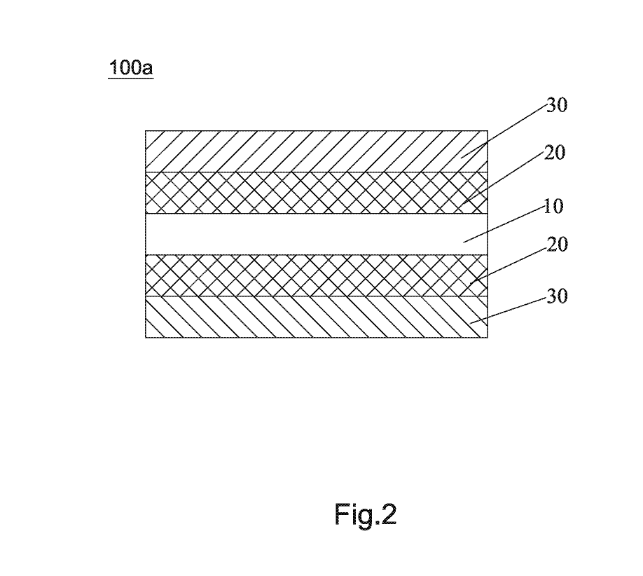

In embodiment 5, as shown in FIG. 2, the thermally insulating glass for ovens 100a includes a glass substrate 10, a thermally insulating layer 20 and a protective layer 30. The glass substrate 10 has an inner surface and an outer surface, and both outer and inner surface is coated with the thermally insulating layer 20 made of silver to strengthen thermally insulating performance of thermally insulating glass for ovens 100a. The protective layer 30 made of methyl silicone oil is coated on the thermally insulating layer 20 for protecting thermally insulating layer 20 from being oxidized. Thickness of the protective layer 30 is 50 μm.

In embodiment 6, a exemplary detailed method of preparing the thermally insulating glass for ovens 100, but not limited to 100, the method includes the steps of:

step a, providing a glass substrate 10;

step b, placing the glass substrate 10 in a first vacuum chamber filled with an inert gas for magnetron sputter coating, with target material being silver; then coating silver on the outer surface of the glass substrate 10 to form the a thermally insulating layer 20 at 100° C.; the inert gas can be argon gas, but not limited to it;

step c, placing the glass substrate 10 in multiple vacuums chambers to be gradually cooled down after the thermally insulating layer 20 is coated; then moving the glass substrate 10 to a second vacuum chamber filled with an inert gas; coating silicone oil on the thermally insulating layer 20 to the protective layer 30 at room temperature; the inert gas can be argon gas, but not limited to it; and

step d, gradually depressurizing in multiple vacuum chambers after the protective layer 30 is coated; lowering pressure from 10⁻³ Pa to 10⁻² Pa, then to 10⁻¹ Pa, but not limited to it.

In embodiment 7, before the step b, the glass substrate 10 is pretreated to increase binding force of the thermally insulating layer 20 and the glass substrate 10. Concretely, the glass substrate 10 is cleaned and dried before the step b.

In embodiment 8, the step b further includes placing the glass substrate 10 in a first vacuum chamber filled with an inert gas for magnetron sputter coating, then coating silver on the outer surface of the glass substrate 10 to form the thermally insulating layer 20 at 250° C. or 150° C. The inert gas can be argon gas, but not limited to it.

In comparative embodiment 1, temperature for preparing the thermally insulating layer 20 was directly reduced from 250° C. to room temperature. While in embodiment 8, temperature for preparing the thermally insulating layer was changed to 250° C. through multiple vacuum chambers and gradually lowered to room temperature. For example, the temperature is reduced from 250° C. to 200° C., then from 200° C. to 150° C., then from 150° C. to 100° C., then from 100° C. to 50° C. and finally to 50° C. Comparing the two embodiments, crack appears in the thermally insulating layer 20 treated by direct cooling, and its thermally insulating performance is poor. And the thermally insulating performance treated by gradual lowering temperature process is excellent.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A thermally insulating glass for ovens, comprising:
a glass substrate comprising an inner surface and an outer surface;
a thermally insulating layer made of silver and provided on the inner surface or/and an outer surface; and
a protective layer made of silicone oil and provided on the thermally insulating layer for preventing the thermally insulating layer from being oxidized.

2. The thermally insulating glass for ovens according to claim 1, wherein the silicone oil is methyl silicone oil or modified silicone oil.

3. The thermally insulating glass for ovens according to claim 2, wherein the modified silicone oil is any one selected from groups of alcoholic hydroxyl-modified silicone oil, alkyl-modified silicone oil, polyether-modified silicone oil, epoxy-modified polysiloxane and amino-modified silicone oil.

4. The thermally insulating glass for ovens according to claim 1, wherein the thickness of the protective layer is 20-50 μm.

5. A method of preparing a thermally insulating glass for ovens, the method comprising:
step a, providing a glass substrate comprising an inner surface and an outer surface;
step b, coating a thermally insulating layer made of silver on the inner surface and/or the outer surface of the glass substrate; and
step c, coating a protective layer made of silicone oil on the thermally insulating layer.

6. The method of preparing a thermally insulating glass for ovens according to claim 5, wherein the step b further comprises placing the glass substrate in a first vacuum chamber for magnetron sputter coating, with target material being silver; then coating the target material on the inner surface and/or the outer surface of the glass substrate to form the thermally insulating layer at 100° C.-250° C.

7. The method of preparing a thermally insulating glass for ovens according to claim 5, before the step c, further comprising cooling down gradually to a room temperature.

8. The method of preparing a thermally insulating glass for ovens according to claim 7, wherein the step c further comprises moving the glass substrate to a second vacuum chamber filled with an inert gas; then coating silicone oil on the thermally insulating layer to form the protective layer.

9. The method of preparing a thermally insulating glass for ovens according to claim 5, after the step c, further comprising depressurizing gradually the glass substrate to obtain the thermally insulating glass for ovens.

10. The method of preparing a thermally insulating glass for ovens according to claim 5, between the steps a and b, further comprising cleaning and drying the glass substrate.
